(19) United States
(12) Patent Application Publication
(10) Pub. No.: US 2001/0040352 A1
(43) Pub. Date: Nov. 15, 2001

(54) Rider propelled vehicle

(76) Inventors: Jar-Chen Wang, Cerritos, CA (US); Hong-Jiun Gu, Taipie City (TW)

Correspondence Address: CHAN LAW GROUP LC, 1055 W. 7TH ST,, SUITE 1880, LOS ANGELES, CA, 90017, US

(21) Appl. No.: 09/833,370

(22) Filed: Apr. 12, 2001

(30) Foreign Application Priority Data
Apr. 12, 2000 (TW) 89205858

(51) Int. Cl. B62M 1/00

(52) U.S. Cl. 280/87.01

(57) ABSTRACT

The vehicle can be used for transportation or recreation. The rider can choose to propel the vehicle by either manipulating the steering mechanism back and forth to “walk” the vehicle forward or backward across the ground or propel it with one foot upon the vehicle and one pushing off of the ground or with ski poles. The vehicle offers all of the mobility of a scooter or skateboard but with the added stability and safety of five wheels. Seated or standing riders can use the scooter. A seated rider can sit directly on the frame or on a raised seat platform. It can be adapted to employ foot manipulation to produce the back and forth “walking” propulsion. The vehicle is capable of adaptation to provide either foot or hand steering. The vehicle is capable of many incarnations including a steerable skateboard, a steerable snowboard and a steerable sidewalk ski-board.

### BACKGROUND OF THE INVENTION

1. Field of the Invention

The present invention relates to a vehicle that can be used for transportation or recreation. The rider can choose to propel the vehicle by either manipulating the steering mechanism back and forth to “walk” the vehicle forward or backward across the ground or when holding the steering mechanism in a straight direction, propel it with one foot upon the vehicle and one pushing off of the ground in a conventional manner. The vehicle offers all of the mobility of a two-wheeled, un-motorized scooter or skateboard but with the added stability and safety of five wheels. The vehicle is capable of many incarnations including a steerable skateboard, a steerable snowboard and a steerable sidewalk ski-board.

2. Description of the Related Art

Recently two-wheeled, un-motorized, rider propelled scooters have become very popular with people of all ages. The high maneuverability and low profile of the scooter makes it fun to ride. However, these same features make these scooters unstable when used by a standing rider. When a standing rider looses her balance or control of the scooter a tipping instability is introduced. This instability can make the scooter dangerous and difficult to use for the casual or inexperienced rider. Using the steering mechanism to turn the board as in the instant invention allows the rider to remain in a more upright and in control position in relation to the board. The instant invention is therefore more stable than a scooter. The vehicle offers all of the mobility of a two-wheeled, un-motorized scooter but with the added stability and safety of five wheels. A seated or standing rider can use the instant invention in contrast to a two-wheeled scooter that accommodates only standing riders. The instant invention can be steered using a hand only or a foot only steering mechanism. A vehicle with more than two wheels and tipping limiting devices would preserve the high maneuverability desired in this type of device and also greatly reduce the associated tipping instability. A two-wheeled scooter lacks the rider propulsion system of the instant invention. The rider propulsion system allows a rider to “walk” the vehicle across the ground without the rider resorting to using a foot to push off of the ground in a typical scooter propulsion manner. A rider can “walk” the vehicle forward or backward. The instant invention also allows the rider to propel the vehicle by using a foot to push off of the ground in a typical scooter propulsion manner.

The traditional skateboard has been popular for many years. Although it typically has four wheels, each side-by-side wheel pair is mounted upon a swivel device with a single swivel point. This arrangement has the effect of balancing the board upon only two support points, a very unsteady arrangement. Similarly, skateboards also possess a high degree of tipping instability and require a very high degree of skill to safely and enjoyably ride them. A vehicle with more than two support points and tipping limiting devices would preserve the high maneuverability desired in this type of device and also greatly reduce the associated tipping instability. The vehicle offers all of the mobility of a skateboard but with the added stability and safety of five wheels. The skateboard lacks the rider propulsion system of the instant invention in which a rider can “walk” the vehicle across the ground and a rider can propel the vehicle by using a foot to push off of the ground in a typical skateboard propulsion manner. A rider can “walk” the vehicle forward or backward. The entire skateboard must be tilted and turned for the rider to effect a directional change, whereas the rider of the instant invention can make a turn by turning the steering device. Using the steering mechanism to turn the board as in the instant invention allows the rider to remain in a more upright and in control position in relation to the board. The instant invention is therefore more stable than a skateboard. A seated or a standing rider can use the instant invention in contrast to a skateboard that accommodates only standing riders. The instant invention can be steered using a foot steering mechanism. The instant invention becomes a steerable sidewalk ski board when fitted with its two snowboard type bindings and propelled by pushing off the ground with rubber tipped ski poles in a typical snowboard propulsion manner.

The snowboard has also developed a high degree of popularity over the last several years. Although snowboards slide directly upon the snow and do not ride on wheels, they also require a high degree of rider skill to ride safely and enjoyably. The low friction connection between the board and the snow that makes the snowboard highly maneuverable also gives it a tipping instability. The entire snowboard must be turned for the rider to effect a directional change whereas the rider of the instant invention can make a turn by turning the steering device. The method of turning the snowboard changes the rider's center of gravity in relation to the snowboard reducing the rider's stability. Using the steering mechanism to turn the board as in the instant invention allows the rider to remain in a more upright and in control position in relation to the board. The instant invention is therefore more stable than a snowboard. A seated or a standing rider can use the instant invention in invention in contrast to a typical snowboard that accommodates only standing riders. The instant invention can be steered using a foot steering mechanism. A snowboard lacks the rider propulsion system of the instant invention. A rider can “walk” the vehicle across the snow or a rider can propel the board by pushing off the ground with ski poles in a typical snowboard propulsion manner. A rider can “walk” the vehicle forward or backward.

One objective of this invention is to create a stable and relatively safe vehicle that a casual rider can use. A second objective is to create a vehicle with enough adaptability that a seated rider or a standing rider can enjoy it. A third objective is to create a vehicle that can be used on rougher terrain than a conventional scooter. A fourth objective is to devise a vehicle that can be self-propelled using either hand or a foot-powered mechanism. A fifth objective is to devise a vehicle that can be adapted into many forms to suit many rider tastes and different terrain types. A final objective is to devise a vehicle that can be produced at a relatively low cost.

### SUMMARY OF THE INVENTION

The invention is a rider-propelled wheeled vehicle called a twist scooter. The twist scooter includes a frame. The frame has a first end, a second end, a first side, a second side, an upper surface, a lower surface and a vertical centerline plane running lengthwise.

A pair of wheel supports is provided. Both of the wheel supports are attached to and supporting the second end of the frame. A wheel is mounted onto a horizontal axle attached to each individual wheel support. Each wheel support is spaced at equal distances on opposite sides of the centerline plane of the frame.

A safety bumper means is provided. The safety bumper means is attached to the lower surface of the second end of the frame, aft of the wheel supports. The safety bumper means is located such that the centerline plane of the frame bisects it. The safety bumper means is sized and shaped to prevent excessive backward tipping of the vehicle on the wheels attached to the wheel supports, but also allow a full range of horizontal movement. The safety bumper means is capable of functioning as a braking device. A braking force is created when the vehicle is intentionally tipped backwards to bring the safety bumper means into frictional contact with the ground.

A vertical steering shaft is provided. The vertical steering shaft has a first end, a second end, and a vertical centerline axis. The vertical steering shaft is rotatably connected through the first end of the frame. The rotatable connection permits a 360 degree swivel of the vertical steering shaft. The vertical steering shaft is vertically disposed. The centerline axis of the vertical steering shaft lies within the centerline plane of the frame.

A tricycle propulsion means is provided. The tricycle propulsion means possesses a propulsion wheel disposed at each of the two corners and a safety wheel assembly disposed at the third corner of the tricycle wheel arrangement. The two propulsion wheels and the safety wheel assembly are attached to the vertical steering shaft by a horizontal support. Each propulsion wheel is parallel to the other propulsion wheel. Both propulsion wheels rotate about a horizontally disposed axle. The horizontally disposed axle is connected to the horizontal support. The safety wheel assembly is sized, shaped and disposed so that it only comes into contact with the ground when the tricycle propulsion means excessively tips over on both the propulsion wheels. The tricycle propulsion means and vertical steering shaft combination supports the first end of the frame. The pair of propulsion wheels is spaced at equal distances on opposite sides of vertical steering shaft. The propulsion wheels rotate in only one direction about its horizontal axle. Both propulsion wheels rotate only in the same direction about their respective horizontal axle.

A rider operable steering means is provided. The rider operable steering means is attached to the second end of the vertical steering shaft. A standing or sitting rider is able to propel and steer the vehicle using only hand-applied force to the rider operable steering means. The hand applied force results in rotation of the vertical steering shaft.

The tricycle propulsion means is adapted to occupy a first neutral position in which the vertical plane of each propulsion wheel is generally parallel to the centerline plane of the frame. The first neutral position permits forward propulsion of the vehicle in a direction parallel to the centerline plane of the frame.

The rider operable steering means is employed by the rider to rotate the tricycle propulsion means. When the tricycle propulsion means is rotated, a reversing force is exerted upon one of the propulsion wheels resulting in the tricycle propulsion means pivoting about the point of contact of the propulsion wheel with the ground. The pivoting of the tricycle propulsion means induces a forward motivating force to be applied to the other propulsion wheel. The motivated propulsion wheel rotates forward until the rider reverses the rotation of the tricycle propulsion means about the vertical steering shaft axis or the vertical plane of the propulsion wheel is perpendicular to the centerline plane of the frame. A reverse direction rotation about the vertical steering shaft reverses the direction of the force applied to each propulsion wheel but still results in forward propulsion of the vehicle. The back and forth rotation about the vertical centerline axis of the vertical steering shaft propels the vehicle forward. The safety wheel assembly imparts no propulsion force into the vehicle during the back and forth rotation about the vertical centerline axis of the vertical steering shaft that propels the vehicle forward. This back and forth manipulation of the steering mechanism results in “walking” propulsion of the vehicle.

The tricycle propulsion means is tailored to occupy second neutral position 180 degrees opposite the first neutral position. When in the second neutral position, the vertical plane of each propulsion wheel is generally parallel to the centerline plane of the frame. The second neutral position permits backward propulsion of the vehicle in a direction parallel to the centerline plane of the frame. The back and forth rotation of the tricycle propulsion means about the vertical steering shaft of up to plus or minus 90 degrees from the second neutral position imparts a generally backward propulsion of the vehicle through a process that is the reverse of the forward propulsion process.

A second version of the invention, a wheel in contact with the ground only when the tricycle propulsion means excessively tips over on both the propulsion wheels, is rotationally connected to the safety wheel assembly. The safety wheel assembly possesses a means for permitting rotation of the wheel about a vertical axis. The safety wheel assembly possesses a means for permitting rotation of the wheel about a horizontal axle.

In a third version of the invention, a removable upper vertical steering shaft support means is provided. The removable upper vertical steering shaft support means possesses a first end and a second end. The first end is able to detachably connect to the upper surface of the first end of the frame. The second end is rotationally attached to the vertical steering shaft.

In a fourth version of the invention, the tricycle propulsion means is detachably connected to the vertical steering shaft.

In a fifth version of the invention, the vertical steering shaft possesses a vertical telescoping extension capability that changes the distance between the first end and the second end of the vertical steering shaft. The vertical steering shaft is composed an outside shaft with a first end, a second end, an outer surface, and a hollow interior and a plurality of concentrically ensleeved inside shafts, each capable of being ensleeved by its corresponding outside shaft to make the vertical steering shaft telescopic. A locking means is affixed to the second end of each outside shaft and provides a locking means against each corresponding ensleeved inside shaft. Each inside shaft is capable of being locked into a user determined telescopic extension length.

In a sixth version of the invention, the second end of the frame accommodates a standing or seated rider.

In a seventh version of the invention, a removable seat extension is provided. The removable seat extension possesses a first end and a second end. The first end is shaped to slideably attach to a receiver means located on the upper surface of the second end of the frame. The second end of the removable seat extension is shaped to comfortably accommodate a seated rider.

In an eighth version of the invention, the rider operable steering means permits the rider to steer or propel the vehicle using the rider's feet. The rider operable steering means is adapted so that a sitting rider is able to propel and steer the vehicle using only foot-applied force to the rider operable steering means. The foot applied force results in rotation of the vertical steering shaft.

In a ninth version of the invention, a pair of foot stirrups is connected to the rider operable steering means. A foot stirrup is connected on opposite sides of the rider operable steering means.

In a tenth version of the invention, a pair of removable cantilevered foot pedals is connected on opposite sides of the vertical steering shaft. A rider's foot force is applied to each removable cantilevered foot pedal to impart a back and forth rotation about the vertical centerline axis of the vertical steering shaft required to propel the vehicle forward.

In an eleventh version of the invention, a foot steering means is provided. The vertical steering shaft has a separation joint located above the rotatable connection through the first end of the frame. The foot steering means is attached to the remaining portion of the vertical steering shaft when the separation joint is disconnected, and the portion the vertical steering shaft above the separation joint is removed. The foot steering means attaches to the rider's footwear through the use of snowboard type bindings. A standing rider's foot through a slight back and forth rotation about the vertical centerline axis of the vertical steering shaft imparts steering changes.

In a twelfth version of the invention, an aft foot holder is provided. The aft foot holder is attached to the upper surface of the frame near its second end. The aft foot holder attaches to the rider's footwear through the use of snowboard type bindings. The rider pushes along with rubber tipped ski poles to generate vehicle propulsion.

In a thirteenth version of the invention, the pair of fixed wheel supports is removed from the frame. A steering ski attached to the first end of the vertical steering shaft replaces the tricycle propulsion means. The safety bumper means is also removed from the frame. These changes transform the vehicle into a steerable snowboard capable of use on snow. Typical ski poles are used for added rider control.

The twist scooter's five-wheel layout creates a stable and relatively safe vehicle for a casual rider to use. The twist scooter is adaptable enough that a seated rider or a standing rider can enjoy it. The twist scooter can be safely used on rougher terrain than a conventional scooter. The twist scooter can be self-propelled using either hand or a foot-powered mechanism. The twist scooter is a vehicle that can be adapted into many forms to suit many rider tastes and different types of terrain. The twist scooter can also be produced and sold for a relatively low cost.

### DESCRIPTION OF THE DRAWINGS

FIG. 1 is a side view canted around a horizontal forward to aft axis to show the upper surface of the frame;

FIG. 2 is a side view of the forward end of the vehicle canted around a horizontal forward to aft axis to show the connection of the tricycle propulsion means to the vertical steering shaft;

FIG. 3 is a side view of the aft end of the vehicle canted about a vertical axis to show the pair of wheel supports and safety bumper means;

FIG. 4 is a trimetric view of the pair of foot stirrups connected on opposite sides of said rider operable steering means;

FIG. 5 is a side view canted around a horizontal forward to aft axis to show a pair of removable cantilevered foot pedals connected on opposite sides of the vertical steering shaft;

FIG. 6 is a cross sectional view of the connection of the pair of removable cantilevered foot pedals to the vertical steering shaft;

FIG. 7 is a side view canted around a horizontal forward to aft axis to show a telescoped vertical steering shaft in a length suitable for a standing rider;

FIG. 8 is a side view canted around a horizontal forward to aft axis to show the removable seat extension including its first end and the receiver means;

FIG. 9 is a side view canted around a horizontal forward to aft axis to show the removable seat extension with its first end installed in the receiver means;

FIG. 10 is a side view canted around a horizontal forward to aft axis to show a pair of removable cantilevered foot pedals connected on opposite sides of the telescoped vertical steering shaft;

FIG. 11 is a front trimetric view showing the first end of the removable upper vertical steering shaft support means is slidably connected to the upper surface of the first end of the frame;

FIG. 12 is a front trimetric view showing the first end of the removable upper vertical steering shaft support means prior to being slidably connected to the upper surface of the first end of the frame;

FIG. 13 is a side view of the steerable skateboard canted around a horizontal forward to aft axis to show the foot steering means attached to the remaining portion of the vertical steering shaft;

FIG. 14 is a side view canted around a horizontal forward to aft axis to show the sidewalk ski board configuration;

FIG. 15 is a side view canted around a horizontal forward to aft axis to show snow ski board configuration;

FIG. 16 is a trimetric view of the steering ski attached at the second end of the vertical steering shaft;

FIG. 17 is a side view of the steerable skateboard canted around a horizontal forward to aft axis to show the foot steering means attached to the remaining portion of the vertical steering shaft and the removable seat extension with its first end installed in the receiver means;

FIG. 18 is a side view of the steerable skateboard canted around a horizontal forward to aft axis to show the foot steering means attached to the remaining portion of the vertical steering shaft, the removable seat extension with its first end installed in the receiver means and rubber tipped ski poles;

FIG. 19 is a side view canted around a horizontal forward to aft axis, to show the snow ski board configuration, the removable seat extension with its first end installed in the receiver means and rubber tipped ski poles.

### DETAILED DESCRIPTION OF THE INVENTION

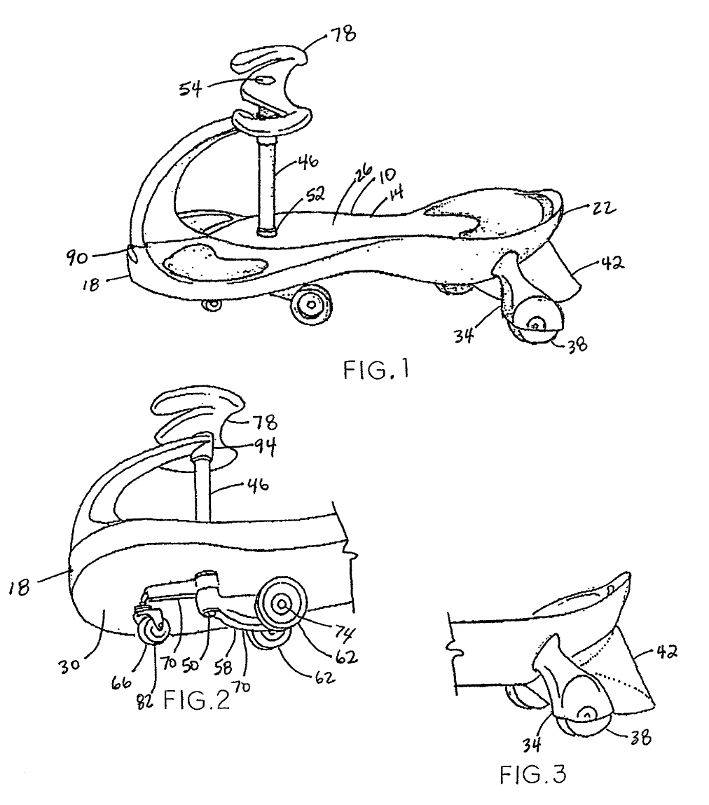

As illustrated in FIGS. 1, 2 and 3, the invention is a rider-propelled wheeled vehicle called a twist scooter 10. The twist scooter 10 includes a frame 14. The frame 14 has a first end 18, a second end 22, a first side, a second side, an upper surface 26, a lower surface 30 and a vertical centerline plane running lengthwise.

A pair of wheel supports 34 is provided. Both wheel supports 34 are attached to and supporting the second end 22 of the frame 14. A wheel 38 is mounted onto a horizontal axle attached to each individual wheel support 34. Each wheel support 34 is spaced at equal distances on opposite sides of the centerline plane of the frame 14.

A safety bumper means 42 is provided. The safety bumper means 42 is attached to the lower surface of the second end of the frame 14, aft of the wheel supports 34. The safety bumper means 42 is located such that the centerline plane of the frame 14 bisects it. The safety bumper means 42 is sized and shaped to prevent excessive backward tipping of the vehicle on the wheels attached to the wheel supports 34, but also allow a full range of horizontal movement. The safety bumper means 42 is capable of functioning as a braking device. A braking force is created when the vehicle is intentionally tipped backwards to bring the safety bumper means 42 into frictional contact with the ground.

A vertical steering shaft 46 is provided. The vertical steering shaft 46 has a first end 50, a second end 54, and a vertical centerline axis. The vertical steering shaft 46 is rotatably connected 52 through the first end 18 of the frame 14. The rotatable connection 52 permits a 360-degree swivel of the vertical steering shaft 46. The vertical steering shaft 46 is vertically disposed. The centerline axis of the vertical steering shaft 46 lies within the centerline plane of the frame 14.

A tricycle propulsion means 58 is provided. The tricycle propulsion means 58 possesses a propulsion wheel 62 disposed at each of the two corners and a safety wheel assembly 66 disposed at the third corner of the tricycle wheel arrangement. The two propulsion wheels 62 and the safety wheel assembly 66 are attached to the vertical steering shaft 46 by a horizontal support 70. Each propulsion wheel 62 is parallel to the other propulsion wheel 62. The pair of propulsion wheels 62 rotates about a horizontally disposed axle 74. The horizontally disposed axle 74 is connected to the horizontal support 70. The safety wheel assembly 66 is sized, shaped and disposed so that it only comes into contact with the ground when the tricycle propulsion means 58 excessively tips over on both the propulsion wheels 62. The tricycle propulsion means 58 and vertical steering shaft 46 combination supports the first end of the frame 14. The pair of propulsion wheels 62 is spaced at equal distances on opposite sides of vertical steering shaft 46. The propulsion wheels 62 rotate in only one direction about its horizontal axle 74. The pair of propulsion wheels 62 rotate only in the same direction about their respective horizontal axle 74.

A rider operable steering means 78 is provided. The rider operable steering means 78 is attached to the second end 54 of the vertical steering shaft 46. A standing or sitting rider is able to propel and steer the vehicle using only hand-applied force to the rider operable steering means 78. The hand applied force results in rotation of the vertical steering shaft 46.

The tricycle propulsion means 58 is adapted to occupy a first neutral position in which the vertical plane of each propulsion wheel 62 is generally parallel to the centerline plane of the frame 14. The first neutral position permits forward propulsion of the vehicle in a direction parallel to the centerline plane of the frame 14.

The rider operable steering means 78 is employed by the rider to rotate the tricycle propulsion means 58. When the tricycle propulsion means 58 is rotated, a reversing force is exerted upon one of the propulsion wheels 62 resulting in the tricycle propulsion means 58 pivoting about the point of contact of the propulsion wheel 62 with the ground. The pivoting of the tricycle propulsion means 58 induces a forward motivating force to be applied to the other propulsion wheel 62. The motivated propulsion wheel 62 rotates forward until the rider reverses the rotation of the tricycle propulsion means 58 about the vertical steering shaft 46 axis or the vertical plane of the propulsion wheel 62 is perpendicular to the centerline plane of the frame 14. A reverse direction rotation about the vertical steering shaft 46 reverses the direction of the force applied to each propulsion wheel 62 but still results in forward propulsion of the vehicle. The back and forth rotation about the vertical centerline axis of the vertical steering shaft 46 propels the vehicle forward. The safety wheel assembly 66 imparts no propulsion force into the vehicle during the back and forth rotation about the vertical centerline axis of the vertical steering shaft 46 that propels the vehicle forward. This back and forth manipulation of the steering mechanism results in “walking” propulsion of the vehicle.

The tricycle propulsion means 58 is tailored to occupy second neutral position 180 degrees opposite the first neutral position. When in the second neutral position, the vertical plane of each propulsion wheel 62 is generally parallel to the centerline plane of the frame 14. The second neutral position permits backward propulsion of the vehicle in a direction parallel to the centerline plane of the frame 14. The back and forth rotation of the tricycle propulsion means 58 about the vertical steering shaft 46 of up to plus or minus 90 degrees from the second neutral position imparts a generally backward propulsion of the vehicle through a process that is the reverse of the forward propulsion process.

In a second version of the invention, a wheel 82 in contact with the ground only when the tricycle propulsion means 58 excessively tips over on both the propulsion wheels 62, is rotationally connected to the safety wheel assembly 66. The safety wheel assembly 66 possesses a means for permitting rotation of the wheel 82 about a vertical axis. The safety wheel assembly 66 possesses a means for permitting rotation of the wheel 82 about a horizontal axle.

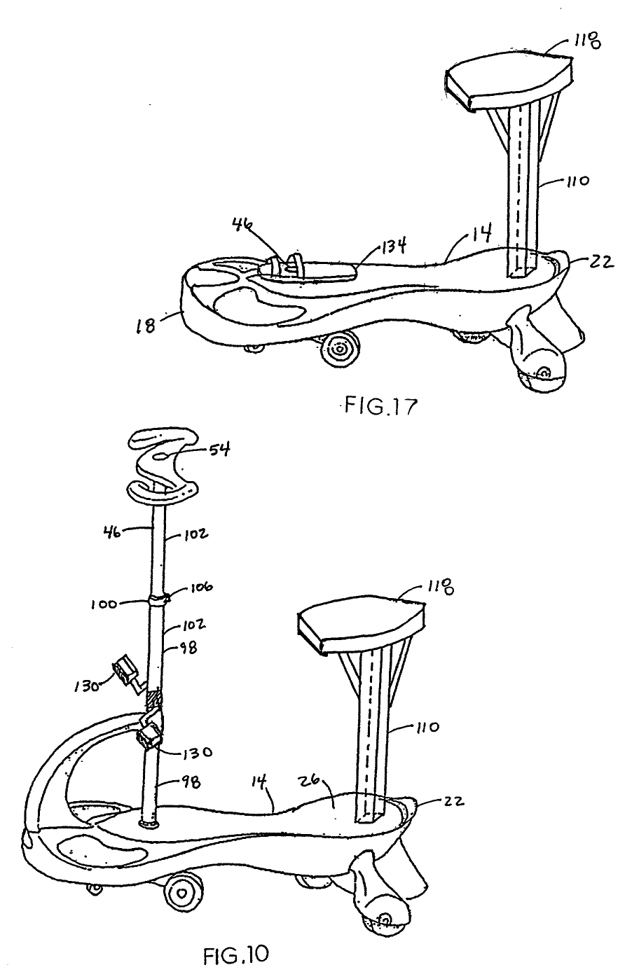

As illustrated in FIGS. 1, 2, 3, 11, and 12, a removable upper vertical steering shaft support means 86 is provided. The removable upper vertical steering shaft support means 86 possesses a first end 90 and a second end 94. The first end 90 is able to detachably connect to the upper surface 26 of the first end 18 of the frame 14. The second end 94 is rotationally attached to the vertical steering shaft 46.

In a different version of the invention, the tricycle propulsion means 58 is detachably connected to the vertical steering shaft 46.

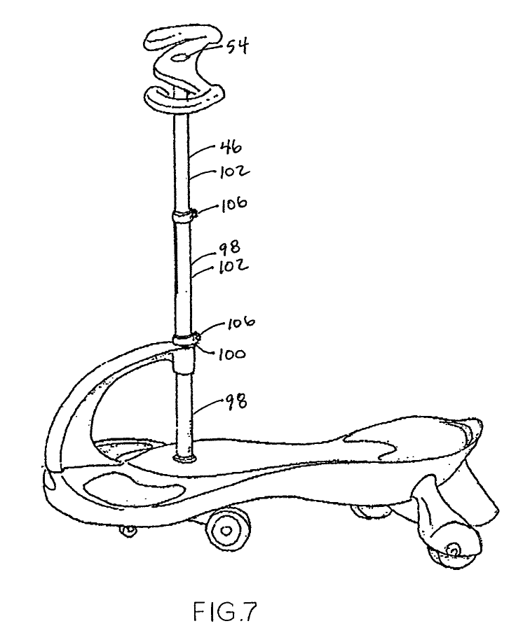

As illustrated in FIGS. 7 and 10, the vertical steering shaft 46 possesses a vertical telescoping extension capability that changes the distance between the first end 50 and the second end 54 of the vertical steering shaft 46. The vertical steering shaft 46 is composed an outside shaft 98 with a first end, a second end 100 an outer surface, and a hollow interior and a plurality of concentrically ensleeved inside shafts 102, each capable of being ensleeved by its corresponding outside shaft 98 to make the vertical steering shaft 46 telescopic. A locking means 106 is affixed to the second end 100 of each outside shaft 98 and provides a locking means 106 against each corresponding ensleeved inside shaft 102. Each inside shaft 102 is capable of being locked into a user determined telescopic extension length.

In still a different version of the invention, the second end of the frame 14 accommodates a standing or a seated rider.

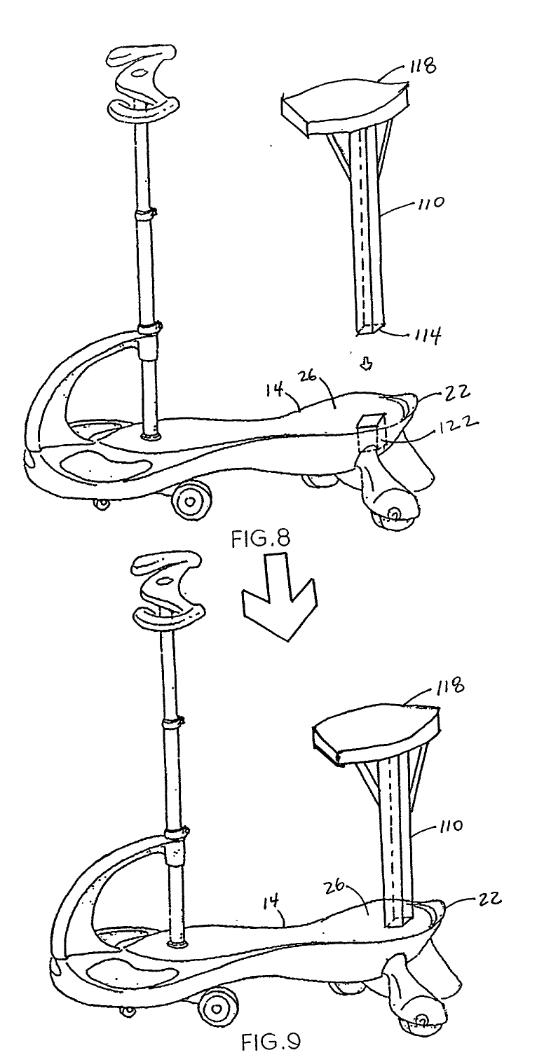

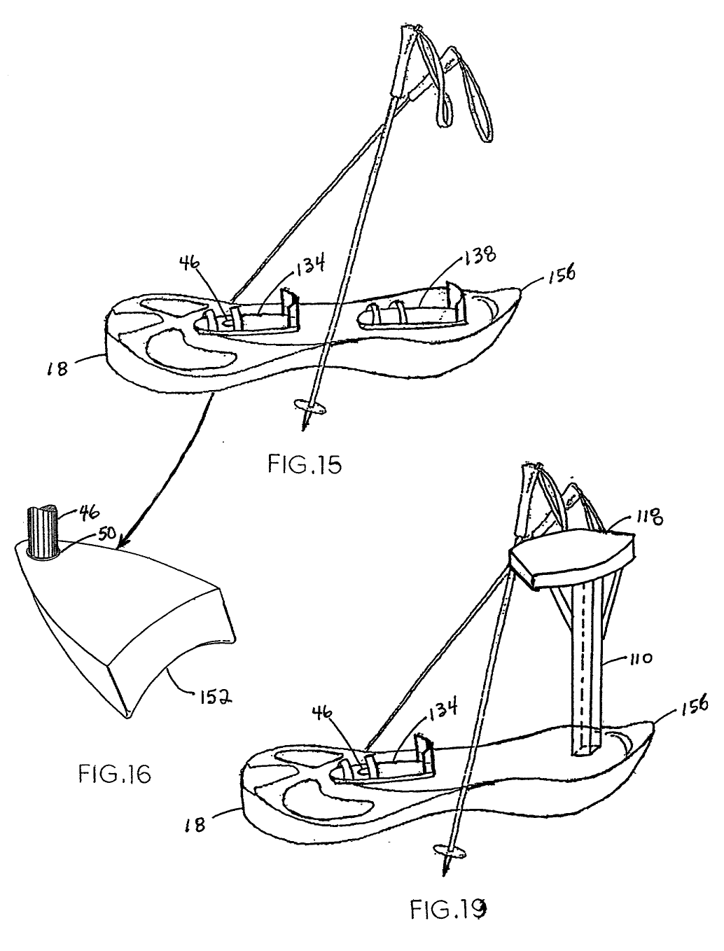

As shown in FIGS. 8, 9, 10, 17, 18 and 19, the removable seat extension 110 is provided. The removable seat extension 110 possesses a first end 114 and a second end 118. The first end 114 is shaped to slideably attach to a receiver means 122 located on the upper surface 26 of the second end 22 of the frame 14. The second end 118 of the removable seat extension 110 is shaped to comfortably accommodate a seated rider.

In another novel version of the invention, the rider operable steering means 78 permits the rider to steer or propel the vehicle using the rider's feet. The rider operable steering means 78 is adapted so that a sitting rider is able to propel and steer the vehicle using only foot applied force to the rider operable steering means 78. The foot applied force results in rotation of the vertical steering shaft 46.

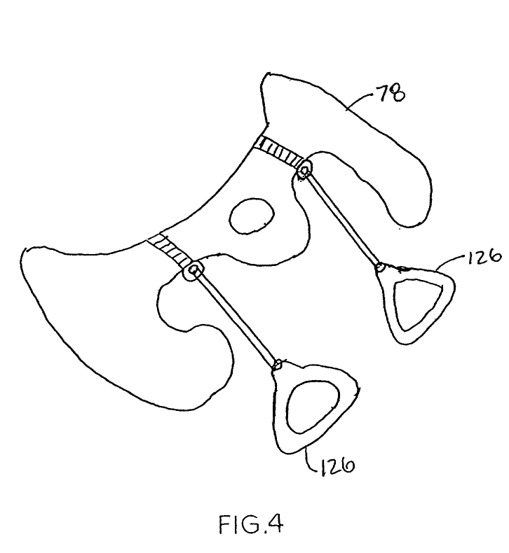

As illustrated in FIG. 4, a pair of foot stirrups 126 is connected to the rider operable steering means 78. A foot stirrup 126 is connected on opposite sides of the rider operable steering means 78.

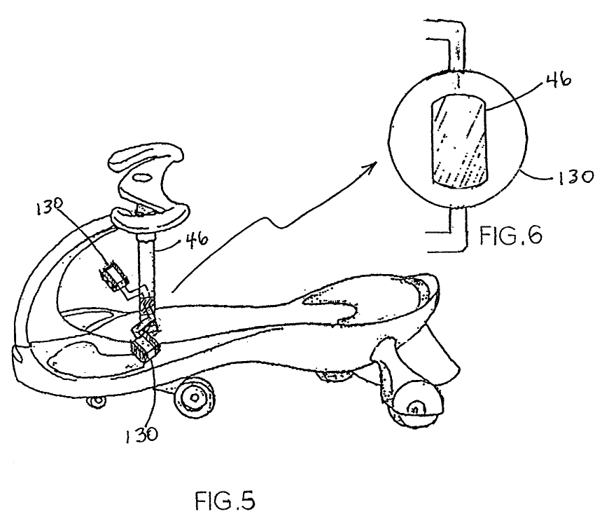

As shown in FIGS. 5, 6 and 10, a pair of removable cantilevered foot pedals 130 is connected on opposite sides of the vertical steering shaft 46. A rider's foot force is applied to each removable cantilevered foot pedal 130 to impart a back and forth rotation about the vertical centerline axis of the vertical steering shaft 46 required to propel the vehicle forward.

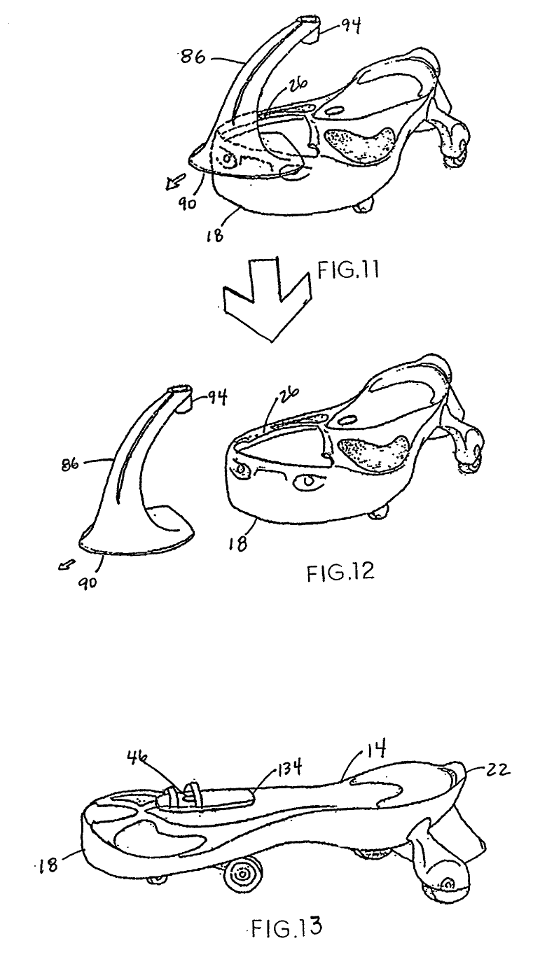

As illustrated in FIGS. 13, 14, 15, 17, 18 and 19, a foot steering means 134 is provided. The vertical steering shaft 46 has a separation joint located above the rotatable connection through the first end of the frame. The foot steering means 134 is attached to the remaining portion of the vertical steering shaft 46 when the separation joint is disconnected, and the portion the vertical steering shaft 46 above the separation joint is removed. The portion of the vertical steering shaft 46 located above the rotatable connection through the first end of the frame 14 is removed. The foot steering means 134 is attached to the remaining portion of the vertical steering shaft 46. The foot steering means 134 attaches to the rider's footwear through the use of snowboard type bindings. A standing rider's foot through a slight back and forth rotation about the vertical centerline axis of the vertical steering shaft 46 imparts steering changes.

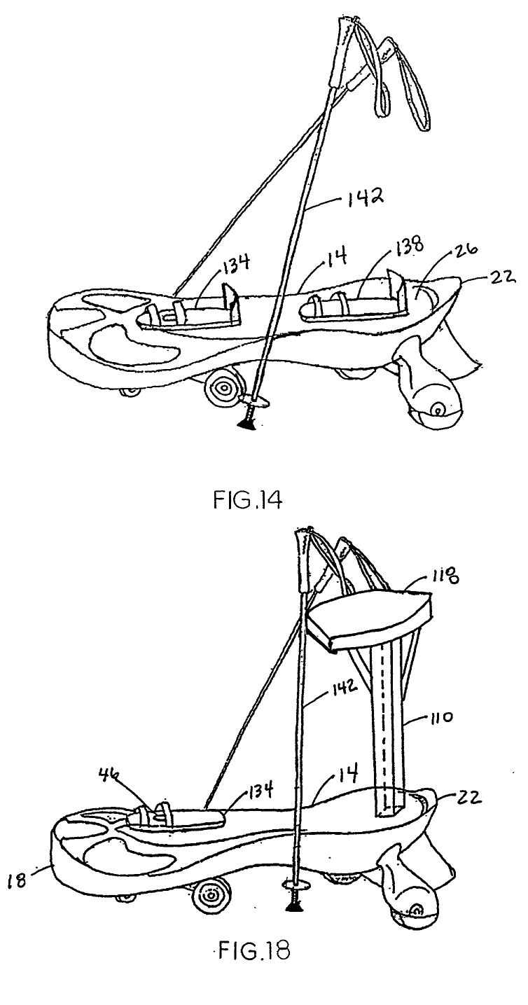

As shown in FIGS. 14, 15 and 17, an aft foot holder 138 is provided. The aft foot holder 138 is attached to the upper surface 26 of the frame 14 near its second end 22. The aft foot holder 138 attaches to the rider's footwear through the use of snowboard type bindings. The rider pushes along with rubber tipped ski poles 142 to generate vehicle propulsion.

As illustrated in FIGS. 15, 16 and 19, the pair of fixed wheel supports 34 is removed from the frame. The tricycle propulsion means 58 is replaced by a steering ski 152 attached to the first end 50 of the vertical steering shaft 46. The safety bumper means 42 is also removed from the frame 14. These changes transform the vehicle into a steerable snowboard 156 capable of use on snow. Typical ski poles 146 are used for added rider control.

What is claimed is:

1. A rider-propelled wheeled vehicle comprising:
a frame, said frame having a vertical centerline plane running lengthwise, a first end, a second end, a first side, a second side, an upper surface and a lower surface;
a pair of wheel supports being provided, the pair of said wheel supports being attached to and supporting said second end of said frame, a wheel being mounted onto a horizontal axle attached to each individual said wheel support, said wheel supports being spaced at equal distances on opposite sides of said centerline plane of said frame;
a safety bumper means being provided, said safety bumper means being attached to said lower surface of said second end of said frame aft of said wheel supports, said safety bumper means being bisected by said centerline plane, said safety bumper means being sized and shaped to prevent excessive backward tipping of the vehicle on said wheels attached to said wheel supports but allow a full range of horizontal movement, said safety bumper means being capable of functioning as a braking device by deliberately tipping the vehicle backwards to bring said safety bumper means into frictional contact with the ground;
a vertical steering shaft being provided, said vertical steering shaft having a first end, a second end and a vertical centerline axis, said vertical steering shaft being rotatably connected through said first end of said frame, said rotatable connection permits a 360 degree swivel of said vertical steering shaft, said vertical steering shaft being vertically disposed, said centerline axis of said vertical steering shaft lies within said centerline plane of said frame;
a tricycle propulsion means being provided, said tricycle propulsion means having a propulsion wheel disposed at each of the two corners and a safety wheel assembly disposed at the third corner of the tricycle wheel arrangement, two said propulsion wheels and said safety wheel assembly being attached to said vertical steering shaft by a horizontal support, a said propulsion wheel being parallel to the other said propulsion wheel, both said propulsion wheels rotate about a horizontally disposed axle, said horizontally disposed axle being connected to said horizontal support, said safety wheel assembly being disposed and sized to prevent excessive tipping of said tricycle propulsion means, said safety wheel assembly being sized shaped and disposed so that it only comes into contact with the ground when said tricycle propulsion means excessively tips over on said propulsion wheels, said tricycle propulsion means and vertical steering shaft combination supports said first end of said frame, said pair of propulsion wheels being spaced at equal distances on opposite sides of vertical steering shaft, said propulsion wheels rotate in only one direction about its said horizontal axle, both said propulsion wheels rotate only in the same direction about said horizontal axle;
a rider operable steering means being provided, said rider operable steering means being attached to said second end of said vertical steering shaft, a standing or a sitting rider being able to propel and steer said vehicle using only hand applied force to said rider operable steering means, the hand applied force results in rotation of said vertical steering shaft;
said tricycle propulsion means being adapted to occupy a first neutral position in which the vertical plane of each said propulsion wheel being generally parallel to said centerline plane of said frame, said first neutral position permit forward propulsion of the vehicle in a direction parallel to said centerline plane of said frame;
said rider operable steering means being employed by the rider to rotate said tricycle propulsion means, the rotation of said tricycle propulsion means results in a reversing force being exerted upon one said propulsion wheel leading to said tricycle propulsion means pivoting about the point of contact of this said propulsion wheel with the ground, the pivoting of said tricycle propulsion means induces a forward motivating force being applied to the other said propulsion wheel, said propulsion wheel rotates forward until the rider reverses the rotation of said tricycle propulsion means about the said vertical steering shaft axis or said vertical plane of said propulsion wheels being perpendicular to said centerline plane of said frame, a reverse direction rotation about the vertical steering shaft reverses the direction of the force applied to each said propulsion wheel but still results in forward propulsion of said vehicle, the back and forth rotation about said vertical centerline axis of said vertical steering shaft propels said vehicle forward, said safety wheel assembly imparts no propulsion force into the vehicle during the back and forth rotation about said vertical centerline axis of said vertical steering shaft that propels said vehicle forward, the back and forth manipulation of said vertical steering shaft results in “walking” propulsion of the vehicle;
said tricycle propulsion means being tailored to occupy a second neutral position 180 degrees the opposite from said first neutral position, in said second neutral position said vertical plane of each said propulsion wheel being generally parallel to said centerline plane of said frame, said second neutral position permits backward propulsion of the vehicle in a direction parallel to said centerline plane of said frame, back and forth rotation of said tricycle propulsion means about said vertical steering shaft of up to plus or minus 90 degrees from said second neutral position imparts a generally backward propulsion of said vehicle through a process being the reverse of the forward propulsion process.

2. A rider-propelled wheeled vehicle according to claim 1 wherein a wheel, in contact with the ground only when said tricycle propulsion means excessively tips over on both said propulsion wheels, said wheel being rotationally connected to said safety wheel assembly, said safety wheel assembly possesses a means for permitting rotation of said wheel about a vertical axis, said safety wheel assembly possesses a means for permitting rotation of said wheel about a horizontal axle.

3. A rider-propelled wheeled vehicle according to claim 1, further comprising a removable upper vertical steering shaft support means, said removable upper vertical steering shaft support means having a first end and a second end, said first end being able to detachably connected to said upper surface of said first end of said frame, said second end being rotationally attached to said vertical steering shaft.

4. A rider-propelled wheeled vehicle according to claim 1 wherein said tricycle propulsion means being detachably connected to said vertical steering shaft.

5. A rider-propelled wheeled vehicle according to claim 1, wherein said vertical steering shaft possesses a vertical telescoping extension capability that changes the distance between said first end and said second end of said vertical steering shaft, said vertical steering shaft being composed an outside shaft with a first end, a second end, an outer surface, and a hollow interior and a plurality of concentrically ensleeved inside shafts each capable of being ensleeved by its corresponding said outside shaft to make said vertical steering shaft telescopic, a locking means being affixed to said second end of each said outside shaft provides a locking means against each corresponding ensleeved said inside shaft, each said inside shaft being capable of being locked into a user determined telescopic extension length.

6. A rider-propelled wheeled vehicle according to claim 1, wherein said second end of said frame accommodates a standing or a seated rider.

7. A rider-propelled wheeled vehicle according to claim 1, further comprising a removable seat extension, said removable seat extension having a first end and a second end, said first end being shaped to slideably attach to a receiver means located on said upper surface of said second end of said frame, said second end of said removable seat extension being shaped to comfortably accommodate a seated rider.

8. A rider-propelled wheeled vehicle according to claim 1 wherein said rider operable steering means permits the rider to steer or propel the vehicle using the rider's feet, said rider operable steering means being adapted so that a sitting rider being able to propel and steer said vehicle using only foot applied force to said rider operable steering means, the foot applied force results in rotation of said vertical steering shaft.

9. A rider-propelled wheeled vehicle according to claim 1, further comprising a pair of foot stirrups being connected to said rider operable steering means, a said foot stirrup being connected on opposite sides of said rider operable steering means.

10. A rider-propelled wheeled vehicle according to claim 1, further comprising a pair of removable cantilevered foot pedals being connected on opposite sides of said vertical steering shaft, a rider foot force being applied to each said removable cantilevered foot pedal to impart the back and forth rotation about said vertical centerline axis of said vertical steering shaft required to propel said vehicle forward.

11. A rider-propelled wheeled vehicle according to claim 1, further comprising a foot steering means, said vertical steering shaft possessing a separation joint located above said rotatable connection through said first end of said frame, when said separation joint being disconnected, the portion above said separation joint being removed, said foot steering means being attached to the remaining portion of said vertical steering shaft, said foot steering means attaches to the rider's footwear through the use of snowboard type bindings, steering changes being imparted by a standing rider's foot through slight back and forth rotation about said vertical centerline axis of said vertical steering shaft.

12. A rider-propelled wheeled vehicle according to claim 11, further comprising an aft foot holder, said aft foot holder being attached to said upper surface of said frame near said second end, said aft foot holder attaches to the rider's footwear through the use of snowboard type bindings, vehicle propulsion being generated by the rider pushing herself along with rubber tipped ski poles.

13. A rider-propelled wheeled vehicle according to claim 12 wherein the pair of said fixed wheel supports being removed from said frame, said tricycle propulsion means being replaced by a steering ski attached to said first end of said vertical steering shaft, said safety bumper means being removed from said frame, transforming said vehicle into a steerable snowboard capable of use on snow, typical ski poles being used for added rider control.
